(19) United States
(12) Patent Application Publication
(10) Pub. No.: US 2004/0171757 A1
(43) Pub. Date: Sep. 2, 2004

(54) Thermosetting acryl powder coating

(76) Inventors: Luc Moens, St. Genesius Rode (BE); Marc Van Muylder, Herent (BE); Nele Knoops, Geraardsbergen (BE); Daniel Maetens, Bruxelles (BE)

Correspondence Address: WENDEROTH, LIND & PONACK, L.L.P., 2033 K STREET N. W., SUITE 800, WASHINGTON, DC, 20006-1021, US

(21) Appl. No.: 10/477,954

(22) PCT Filed: May 21, 2002
(86) PCT No.: PCT/EP02/05545

(30) Foreign Application Priority Data
May 22, 2001 (EP) 01112485.6

(51) Int. Cl. C08L 37/00; C08L 41/00; C08L 29/00

(52) U.S. Cl. 525/190; 525/208; 525/231

(57) ABSTRACT

The present invention relates to a composition for thermosetting powder coating having excellent low temperature curability and good storage stability, being capable of giving a coating with good appearance, flexibility and solvent resistance. The powder coating composition comprises a blend of two different glycidyl group containing acrylic copolymers and a polycarboxylic acid curing agent.

The present invention relates to a composition for thermosetting powder coating, its preparation and use as well as articles coated with this composition. More particular, this invention relates to powder coating compositions comprising a blend of two glycidyl group containing acrylic copolymers and a polycarboxylic acid constituent.

Thermosetting powder coating compositions are extensively used to produce durable protective coatings on various materials. Thermosetting powder compositions possess certain significant advantages over solvent-based coating compositions, which are inherently undesirable because of the environmental and safety problems occasioned by the evaporation of the solvent system. Besides, solvent-based coating compositions also suffer from the disadvantage of relatively poor percentage of utilisation, i.e. for some types of application only 60 percent or less of the solvent-based coating composition contacts the substrate being coated.

Plastic materials used in the manufacture of powder coatings are classified broadly as either thermosetting or thermoplastic. In the application of thermoplastic powder coatings, heat is applied to the coating on the substrate to melt the particles of the powder coating and thereby permit the particles to flow together and form a smooth coating.

Thermosetting coatings, when compared to coatings derived from thermoplastic compositions, generally are tougher, more resistant to solvents and detergents, have better adhesion to metal substrates and do not soften when exposed to elevated temperatures. However, the curing of thermosetting coatings has created problems in obtaining coatings which have, in addition to the above-stated desirable characteristics, good smoothness and flexibility. Coatings prepared from thermosetting powder compositions, upon the application of heat, may cure or set prior to forming a smooth coating, resulting in a relatively rough finish referred to as an “orange peel” surface. Such a coating surface or finish lacks the gloss and luster of coatings typically obtained from thermoplastic compositions.

In order to serve the commercial purpose, coatings derived from thermosetting coating compositions should exhibit or possess good impact-strength, hardness, smoothness and resistance to solvents. For example, good flexibility is essential for powder coating compositions used to coat sheet (coil) steel which is destined to be formed or shaped into articles used in the manufacture of various household appliances and automobiles wherein the sheet metal is flexed or bent at various angles. Besides, It is essential that powder coating compositions remain in a free-flowing, finely divided state for a reasonable period after they are manufactured and packaged.

Powder paints are applied to the substrate as a powder using an electrostatic or friction charging spraygun, the fluidized bed technique or others and are adapted to flow out on the substrate upon heat curing of the powder.

Powder coatings based on carboxylic acid or hydroxyl group containing amorphous polyesters with glasstransition temperature between 45 and 80° C. and a curing agent having groups reactive with carboxylic acid groups or the hydroxyl groups are widely used. Besides, for certain applications where outstanding weatherability is required, acrylic copolymers containing hydroxyl, carboxyl or glycidyl functional groups, along with a curing agent having groups reactive with the acrylic copolymer functional groups, are of particular interest.

EP-A-0 038 635 discloses a resin composition for powder coating consisting essentially of 60 to 97% by weight of a polyester resin and 40 to 3% by weight of a glycidyl-containing acrylic polymer. The glycidyl-containing acrylic polymer suitably has a number average molecular weight of 300 to 5000 and an epoxy equivalent of 130 to 2000.

Since the powder coating contains a single acrylic copolymer, a copolymer of high softening point is required in order for the coating to have good storage stability (e.g. good anti-blocking property). Hence, a high temperature of 160° C. or more is necessary in the backing of the coating in order for the binder system in the coating to be sufficiently melted. Thus, the coatings have no low-curing such as currently employed for the backing of solvent-type acrylic-melamine coatings and further exhibit no sufficient fluidity during the backing and resultantly give a coating film of inferior smoothness and appearance, even at higher curing temperatures.

In JP 52077137, there is disclosed a resin composition for powder coating comprising 100 parts by weight of an acrylic polymer mixture and 3-55 parts by weight of a particular aliphatic dibasic acid, the acrylic copolymer mixture comprising:

(A) 30-70% by weight of a copolymer composed mainly of 10-50% by weight of glycidyl(meth)acrylate and 30-85% by weight of an alkyl(meth)acrylate and having a secondary transition temperature of 0-60° C. and a number average molecular weight of 1000 to 5000, and

(B) 70-30% by weight of a copolymer composed of mainly 3-25% by weight of glycidyl(meth)acrylate, 30-87% by weight of an alkyl(meth)acrylate and 10-30% by weight of unsubstituted or nucleus substituted styrene and having a secondary transition temperature of 30-100° C. and a number average molecular weight of 10000-70000.

EP-A-0 544 206 relates to a composition for thermosetting powder coating, which comprises (a) and acrylic copolymer of high softening point having an epoxy equivalent of 250-1000 g/eq and a softening point of 90-160° C., (b) an acrylic copolymer of low softening point having an epoxy equivalent of 200-600 g/eq and a softening point of 30-70° C., and (c) a polycarboxylic acid. The glasstransition temperature of the acrylic copolymer (a) of high softening point is appropriately 70-120° C. and the number average molecular weight is 2500 to less than 10000. The glasstransition temperature of the acrylic copolymer (b) of low softening point is appropriately in the range of −30 to 40° C. and the number average molecular weight is 500-2000.

In U.S. Pat. No. 4,988,767, there is disclosed a thermosetting powder coating composition which comprises a co-reactable particle mixture of an acid group containing acrylic polymer having a glasstransition temperature in the range of −20° C. to 30° C., an acid group containing acrylic polymer having a glasstransition temperature in the range of 40° C. to 100° C. and a curing agent therefore. Both the high and low glasstransition temperature acid group containing acrylic polymers preferably have a number average molecular weight of about 1500 to 15000.

Each of the above three documents discloses mixed use of acrylic copolymers differing in glasstransition temperature and/or number average molecular weight. However, for the first two documents the resin having the highest glasstransition temperature proves to have the highest number average molecular weight while the resin having the lowest glass transition temperature is characterized by the lowest number average molecular weight. For the third document both, the resin having the low glasstransition temperature as well as the resin having the high glasstransition temperature are situated within the same range of number average molecular weight.

In each of the above three documents, powder compositions having good powder stability, good appearance and flexibility are claimed. Nevertheless, as appears from comparative examples, insufficient storage stability as well as low mechanical properties (direct and reverse impact according to ASTM G 2794) are obtained after a curing schedule of 5 to 30 minutes at temperatures between 120 and 200° C. Besides, at these low curing temperatures, a paint film proving an orange peel aspect is perceived.

In fact, in JP 52077137 and EP-A-0 544 206, the powders are derived from high glass transition temperature, high number average molecular weight resins. This will give upon application and curing severe orange peel. To remedy this phenomenon, in both patents, an external plasticising acrylic copolymer with low number average molecular weight is added to the formulation. Yet the influence on flow only can be observed once high quantities of low glass transition temperature, low number average molecular weight resins are used which have a very negative influence on storage stability and powder processing. Thus the negative influence of low glass transition temperature, low number average molecular weight resins on powder storage stability and processing is much more pronounced thant its positive effect on flow.

In conclusion, it can be seen that the various nowadays powdered thermosetting compositions, derived from a glycidyl group containing acrylic copolymer and a polyacid crosslinker, leave room for improvement. There is thus still a need for such powdered thermosetting compositions, but producing smooth finished coatings with good impact strength after curing. Besides, the powders giving cause for such finishes, should remain in a free-flowing, finely divided state after a reasonable period of storage.

It is accordingly an object of this invention to provide a thermosetting powder coating composition being appropriate for low temperature curability i.e. a powder coating composition giving a coating film proving outstanding film properties such as gloss and smoothness as well as sufficient flexibility after baking generally at about 120 to 200° C., for a curing period generally of about 5 to 30 minutes. A further object of this invention Is to provide a powder coating composition remaining in a free-flowing finely divided state for a reasonable period after they are manufactured and packaged.

It has now unexpectedly been found that the above problems can be solved by incorporating a blend of two glycidyl group containing acrylic copolymers in a composition for thermosetting powder coating wherein one of the acrylic copolymers has a high glasstransition temperature and a low number average molecular weight while the other of the acrylic copolymers has a low glasstransition temperature and a high number average molecular weight.

Thus, the present invention relates to a composition for thermosetting powder coating comprising a co-reactable blend of two glycidyl group containing acrylic copolymers and a polycarboxylic acid constituent, characterized in that said co-reactable blend of glycidyl group containing acrylic copolymers comprises 60-95 parts by weight of a glycidyl group containing acrylic copolymer (a) having a glasstransition temperature in the range of from +45 to +100° C. (DSC 20°/min) and a number average molecular weight in the range of from 2500 to 5000 (GPC/homodisperse polystyrene standards) and 5 to 40 parts by weight, of a glycidyl group containing acrylic copolymer (b) having a glasstransition temperature in the range of from −50 to +30° C. (DSC 20°/min) and a number average molecular weight in the range of from 5000 to 20000 (GPC/homodisperse polystyrene standards). The parts by weight given for the copolymers (a) and (b) both being in relation to the total weight of (a) and (b).

For the purpose of this specification amounts are always given in parts by weight, if nothing else is stated. Moreover, the term (meth)acrylate refers to acrylate, methacrylate or a mixture of acrylate and methacrylate.

The acrylic copolymer (a) preferably exhibits a glasstransition temperature in the range of from +45° to +85° C. The acrylic copolymer (b) preferably exhibits a glasstransition temperature of less than +30° C. such as in the range of from −40° C. to +25° C.

In the present invention, the epoxy group-containing monomer used in the acrylic copolymers (a) and (b), may be used in mole percentages in relation to the total of the monomers of the copolymers ranging from 5 to 99 and preferably is selected from, for example, glycidylacrylate, glycidylmethacrylate, methylglycidylmethacrylate, methylglycidylacrylate, 3,4-epoxycyclohexylmethyl(meth)acrylate, 1,2-ethyleneglycol glycidylether(meth)acrylate, 1,3-propyleneglycolglycidylether(meth)acrylate, 1,4-butyleneglycolglycidylether(meth)acrylate. 1,6-hexanediolglycidylether(meth)acrylate, 1,3-(2-ethyl-2-butyl)-propanediolglycidylether(meth)acrylate and acrylic glycidylethers. These can be used singly or in combination of two or more.

The other monomers copolymerizable with the above epoxy group-containing monomer used in the acrylic copolymers (a) and (b) may be used in mole percentages in relation to the total of the monomers of the copolymers ranging from 1 to 95 and preferably are selected from (meth)acrylic acid esters such as methyl(meth)acrylate, ethyl(meth)acrylate, propyl(meth)acrylate, n-butyl(meth)acrylate, isobutyl(meth)acrylate, tert.butyl(meth)acrylate, 2-ethylhexyl(meth)acrylate, stearyl(meth)acrylate, tridecyl(meth)acrylate, cyclohexyl(meth)acrylate, n-hexyl(meth)acrylate, benzyl(meth)acrylate, phenyl(meth)acrylate, isobornyl(meth)acrylate, nonyl(meth)acrylate, hydroxyethyl(meth)acrylate, hydroxypropyl(meth)acrylate, hydroxybutyl(meth)acrylate and 1,4-butanediol mono(meth)acrylate, the esters of methacrylic acid, maleic acid, maleic anhydride and itaconic acid, dimethylaminoethyl(meth)acrylate and diethylaminoethyl(meth)acrylate.

Other monomers copolymerizable with the epoxy-containing monomer also include, for example, styrene, α-methylstyrene, vinyltoluene, (meth)acrylonitrile, vinylacetate, vinylpropionate, acrylamide, methacrylamide, methylol(meth)acrylamide, vinylchloride, ethylene, propylene, C4-20 olefins and α-olefins.

Appropriately, the epoxy group-containing monomer is used in such an amount that the resulting acrylic copolymer (a) has an epoxy equivalent of 200 to 800 g/eq. and the resulting acrylic copolymer (b) has an epoxy equivalent of 200 to 1000 g/eq. The epoxy equivalent is expressed by weight (g) of acrylic copolymer per equivalent of epoxy group and is expressed in gram per equivalent (g/eq.).

Appropriately, the polycarboxylic acid constituent Is used in such an amount that the equivalent ratio of the total epoxy groups of the acrylic copolymer (a) of high glasstransition temperature and the acrylic copolymer (b) of low glasstransition temperature to the acid groups of the polycarboxylic acid constituent is 0.5 to 2 and preferably 0.8 to 1.2.

The glycidyl group containing acrylic copolymers each may be prepared by conventional polymerization techniques, either in mass, in emulsion, or in solution in an organic solvent. The nature of the solvent is very little of importance, provided that it is inert and that it readily dissolves the monomers and the synthesised copolymer. Suitable solvents include toluene, ethyl acetate, xylene, etc. The monomers are advantageously copolymerized in the presence of a free radical polymerization initiator (benzoyl peroxide, dibutyl peroxide, azobis-isobutyronitrile, and the like) in an amount representing 0.1 to 4% by weight of the monomers. To achieve a good control of the molecular weight and its distribution, a chain transfer agent, preferably of the mercaptan type, such as n-dodecylmercaptan, t-dodecanethiol, isooctylmercaptan, or of the carbon halide type, such as carbon tetrabromide, bromotrichloromethane, etc., may also be added in the course of the reaction. If present, the chain transfer agent is used in an amount of from 0.1 to 10%, preferably between 2 and 5% by weight of the monomers used in the copolymerization.

A cylindrical, double walled reactor equipped with a stirrer, a condenser, an inert gas (nitrogen, for example) inlet and outlet, and metering pump feed systems Is generally used to prepare the glycidyl group-containing acrylic copolymer. Polymerization is carried out under conventional conditions. Thus, when polymerization is carried out in solution, for example, an organic solvent is introduced into the reactor and heated to reflux temperature under an inert gas atmosphere (nitrogen, carbon dioxide, and the like) and a homogeneous mixture of the required monomers, free radical polymerization initiator and chain transfer agent is then added to the solvent gradually over several hours. The reaction mixture is then maintained at the indicated temperature for some hours, while stirring, and the major portion of the solvent is then distilled off. The copolymer obtained is subsequently freed from the remainder of the solvent in vacuo.

It is a further embodiment of this invention to prepare first of all the low glasstransition temperature, high number average molecular weight acrylic copolymer according one of the procedures as described above. The acrylic copolymer thus obtained subsequently can be freed or not from remaining solvent and is used in a further stage as a polymeric diluent for the synthesis of the high glasstransition temperature, low number average molecular weight acrylic copolymer.

For the case where the low glasstransition temperature, high number average molecular weight acrylic copolymer first is completely freed of remaining solvent, the high glasstransition temperature, low number average molecular weight copolymer and thus the acrylic copolymer blend is accordingly prepared by a polymerization process essentially in the absence of volatile components. Alternatively, the two acrylic copolymers can be blended in the melt using a conventional cylindrical double-walled reactor or by extrusion such as by the Betol BTS40. For reasons of processability, it is preferred to produce the copolymer blend by polymerizing the high glasstransition temperature copolymer in the low glasstransition temperature copolymer.

The polycarboxylic acid constituent used in the present composition is a curing agent component for reacting with the epoxy groups contained in the acrylic copolymer (a) of high glasstransition temperature and the acrylic copolymer (b) of low glasstransition temperature.

The polycarboxylic acid constituent contains at least two carboxyl groups or anhydrides thereof and is exemplified by aliphatic dibasic acids such as adipic acid, pimelic acid, suberic acid, azelaic acid, sebacic acid, undecanedloic acid, tridecanedioic acid, tetradecanedioic acid, pentadecanedioic acid, hexadecanedioic acid, octadecanedioic acid, eicosanedioic acid, 1,10-dodecanedioic acid, docosanedioic acid and tetracosanedioic acid, aromatic polycarboxylic acids such as phthalic anhydride, isophthalic acid and trimellitic acid and alicyclic dibasic acids such as 1,2-cyclohexanedicarboxylic acid, 1,3-cyclohexanedicarboxylic acid, 1,4-cyclohexanedicarboxylic acid, hexahydrophthalic acid and tetrahydrophthalic acid.

Besides the above polybasic acids, there can also be used polyester resins having carboxylic groups. The carboxyl group functionalised polyesters are derived from at least one compound containing at least two carboxyl groups or anhydrides thereof esterified with at least one polyhydric alcohol. The polyester resins are preferably linear.

The acid constituent of the carboxyl group-containing polyester may be an organic dicarboxylic acid, such as terephthalic acid, fumaric acid, maleic acid, isophthalic acid, phthalic acid, adipic acid, succinic acid, 1,2-cyclohexanedicarboxylic acid, 1,3-cyclohexanedicarboxylic acid, 1,4-cyclohexanedicarboxylic acid, 1,10-dodecanedioic acid, glutaric acid, pimelic acid, suberic acid, azelaic acid, sebacic acid, and the like, alone or in admixture. These acids can be used in the form of the free acid or, if appropriate, in the form of the anhydride, or also in the form of an ester with a lower aliphatic alcohol.

The alcohol constituent of the carboxyl group-containing polyester may be an organic dihydroxy compound, which is preferably selected from the aliphatic diols, such as neopentyl glycol, ethylene glycol, diethylene glycol, 1,4-butanediol, 1,6-hexanediol, hydroxylpivalate of neopentyl glycol, 1,4-cyclohexanedimethanol, 1,4-cyclohexanediol, 2,2-bis(4-hydroxycyclohexyl)propane, propylene glycol, hydrogenated Bisphenol A, 2-ethyl-2-butyl-1,3-propanediol, 2-methyl-1,3-propanediol and the like, alone or in admixture.

If desired, a branching of the polyester can be obtained by incorporation of polyols or polyacids or corresponding anhydrides such as trimethylolpropane, di-trimethylolpropane, pentaerythritol, trimellitic anhydride, pyromellitic anhydride, etc.

According to the invention, the carboxyl group containing polyester used, preferably has an acid number of 20 to 150 mg KOH/g, a hydroxyl number of not more than 15 mg KOH/g, a number average molecular weight of 750 to 8000 (GPC homodisperse polystyrene standards), a glasstransition temperature of −20° C. (DSC 20°/min) or greater and optionally a melting temperature of +50° C. or greater (DSC).

The carboxyl group-containing polyesters can be prepared by conventional methods for synthesizing polyesters by direct esterification or by transesterification, in one or more steps.

The polycarboxylic acid constituent synthesis is generally carried out in a reactor equipped with a stirrer, an inert gas (nitrogen, for example) inlet and outlet, a thermocouple, an adiabatic column, a condenser, a water seperator and a vacuum connection tube. The esterification conditions are preferably the conventional conditions, that is to say a conventional esterification catalyst, such as dibutyltinoxide or n-butyltin trioctanoate, can be used in an amount of 0.1 to 0.5% by weight of the reagents, and optionally an antioxidant, for example tributylphosphite, can be added in amount of 0.01 to 0.5% by weight of the reagents.

The thermosetting powder composition of the present invention thus comprises a binder composition being composed of:

a) a glycidyl group containing acrylic copolymer having a high glasstransition temperature and a low number average molecular weight,

b) a glycidyl group containing acrylic copolymer having a low glasstransition temperature and a high number average molecular weight, and

c) a polycarboxylic acid and/or carboxyl group functionalized polyester preferably used in such an amount that the equivalent ratio of epoxy to acid groups is 0.5 to 2 and preferably 0.8 to 1.2.

In this binder composition the components (a) and (b) being present in amounts of 60-95 parts by weight of (a) and 5-40 parts by weight, of (b) both in relation to the total weight of (a) and (b), when the carboxyl group functionalized polyester is used as the curing agent.

When polycarboxylic acids are used as curing agent, in the binder composition, the components (a) and (b) are present in an amount of 60-80 parts by weight, of (a) and 20-40 parts by weight, of (b), both in relation to the total weight of (a) and (b).

In addition to the essential components described above, compositions within the scope of the present invention can also include flow control agents such as Resiflow PV5 (Worlee), Modaflow (Monsanto), Acronal 4F (BASF), etc., and degassing agent such as benzoin (BASF), etc. To the formulation of the polyester UV-light absorbers such as Tinuvin 900 from Ciba Geigy and hindered amine light stabilisers represented by Tinuvin 144 (Ciba Geigy) are useful.

Both, pigmented systems as well as clear lacquers can be prepared. A variety of dyes and pigments can be utilised in the composition of this invention. Examples of useful pigments and dyes are: metallic hydroxides such as titaniumdioxide, ironoxide, zincoxide and the like, metal hydroxides, metal powders, sulphides, sulphates, carbonates, silicates such as ammoniumsilicate, carbon black, talc, china clay, barytes, iron blues, leadblues, organic reds, organic maroons and the like.

The components of the composition according to the invention may be mixed by dry blending in a mixer or blender (e.g. drum mixer). The premix may then be homogenised at temperatures ranging from 65 to 95° C. in a single screw extruder such as the Buss-Ko-Kneter or a double screw extruder such as the PRISM or A.P.V. The extrudate, when cooled down, is grounded to a powder having a particle size preferably ranging from 10 to 150 μm.

The powdered composition may be deposited on the substrate by use of a powder gun such as an electrostatic CORONA gun or TRIBO gun. On the other hand well known methods of powder deposition such as the fluidized bed technique can be used. After deposition the powder Is heated to a temperature between 120 to 200° C. for a period ranging from 5 to 30 minutes, causing the particles to flow and fuse together to form a smooth, uniform, continuous, uncratered coating on the substrate surface.

Thus, the compositions of the present invention have excellent low temperature curability and good storage stability, being capable of giving a coating with good appearance, flexibility and solvent resistance.

The following examples are submitted for a better understanding of the invention without being restricted thereto (Mn=number average molecular weight, Tg=glasstransition temperature).

### EXAMPLE 1

### Preparation of a Glycidyl Group Containing Acrylic Copolymer Blend

a) Preparation of the low glasstransition temperature glycidyl group containing acrylic copolymer.

278.65 parts of n-butylacetate are brought in a double walled flask of 5 l equipped with a stirrer, a water cooled condensor and an inlet for nitrogen and a thermoprobe attached to a thermoregulator.

The flask content is then heated and stirred continuously while nitrogen is purged through the solvent. At a temperature of 92° C. a mixture of 69.66 parts of n-butylacetate with 0.071 parts of 2,2′-azobis (2-methylbutanenitrile) are fed in the flask during 215 minutes with a peristaltic pump. 5 minutes after this start another pump is started with the feeding of 30.48 parts of glycidylmethacrylate, 7.22 parts of butylacrylate, 71.15 parts of butylmethacrylate and 0.039 parts of n-dodecylmercaptane during 180 minutes. 315 minutes after the starting of the synthesis, an acrylic copolymer, with following characteristics is obtained:

Mn=9120

Tg (DSC)=12° C.

Epoxy equivalent weight=508 g/equivalent.

b) Preparation of the high glasstransition temperature glycidyl group containing acrylic copolymer in the low glasstransition temperature glycidyl group containing acrylic copolymer, used as polymeric diluent.

457.27 parts of the acrylic copolymer solution, as obtained above then are brought in a double walled flask of 5 l equipped with a stirrer, a water cooled condensor and an inlet for nitrogen and a thermoprobe attached to a thermoregulator. The flask content is then heated and stirred continuously while nitrogen is purged through the solvent. At a temperature of 92° C. a mixture of 87.08 parts of n-butylacetate with 5.51 parts of 2,2′-azobis (2-methylbutanenitrile) are fed in the flask during 215 minutes with a peristaltic pump. 5 minutes after this start another pump is started with the feeding of 121.9 parts of glycidylmethacrylate, 65.3 parts of styrene, 209.21 parts of methylmethacrylate and 17.80 parts of n-dodecylmercaptane. The synthesis (start-emptying flask) takes 315 minutes. The flask content is dried by means of a rotary evaporator at 160° C. (setpoint of oil bath temperature) after which an acrylic copolymer blend with following characteristics is obtained:

Mn=4900

Tg (DSC)=64° C.

Epoxy equivalent weight=527 g/equivalent.

### EXAMPLES 2 to 10

### Preparation of Glycidyl-group Containing Acrylic Copolymer Blends

Adopting the procedure described in example 1, other glycidyl-group containing acrylic copolymer blends are prepared (examples 2 to 10). These blends, along with the blend of example 1, are described in tables 1 to 4 in which successively the following data are given:

Tables 1 and 3: low glasstransition temperature glycidyl-group containing acrylic copolymer (EX1L to EX10L).

A: parts of n-butylacetate initially brought in the reactor

B: parts of n-butylacetate containing the radical initiator

C: parts of radical initiator (2,2′-azobis (2-methylbutanenitrile))

D: mixture of polymerizable monomers and transfer agent.

Tables 2 and 4: blend of high glasstransition temperature glycidyl-group containing acrylic copolymer prepared in low glasstransition temperature glycidyl-group containing acrylic copolymer. (EX1B to EX10B)

A: parts of acrylic copolymer solution as prepared in tables 1 and 3

B: parts of n-butylacetate containing the radical initiator

C: parts of radical initiator (2,2′-azobis (2-methylbutanenitrile))

D: mixture of polymerizable monomers and transfer agent

TABLE 1

| | Example 1L | Example 2L | Example 3L | Example 4L | Example 5L |
|---|---|---|---|---|---|
| A | 278.65 | 278.52 | 266.85 | 261.37 | 272.56 |
| B | 69.66 | 69.93 | 66.71 | 65.34 | 68.14 |
| C | 0.071 | 0.544 | 0.730 | 0.817 | 0.639 |
| Mixture D | | | | | |
| GMA | 30.48 | 30.46 | 40.86 | 45.74 | 71.55 |
| BuA | 7.22 | 58.24 | 78.12 | 87.47 | 42.16 |
| BuMA | 71.15 | 20.09 | 26.96 | 30.15 | 14.05 |
| n-DDSH | 0.039 | | | | |
| Tg (DSC), ° C. | 12 | −42 | −38 | −41 | −52 |
| Mn (GPC) | 9120 | 15655 | 18355 | 19570 | 13650 |
| EEW, g/eq | 508 | 510 | 510 | 510 | 255 |

TABLE 2

| | Example 1B | Example 2B | Example 3B | Example 4B | Example 5B |
|---|---|---|---|---|---|
| A | 457.27 | 457.48 | 480.22 | 490.88 | 469.09 |
| B | 87.08 | 87.04 | 83.39 | 81.68 | 85.17 |
| C | 5.51 | 5.51 | 5.27 | 5.17 | 5.39 |
| Mixture D | | | | | |
| GMA | 121.9 | 121.9 | 116.7 | 114.3 | 238.5 |
| Styrene | 65.3 | 65.3 | 62.5 | 61.3 | 63.9 |
| MMA | 209.21 | 152.31 | 145.93 | 142.94 | 85.17 |
| BuMA | 38.90 | 95.74 | 91.73 | 89.85 | 38.33 |
| IBOA | | | | | |
| n-DDSH | 17.80 | 14.80 | 14.18 | 13.89 | 14.48 |
| Tg (DSC), ° C. | 64 | 57 | 55 | 53 | 55 |
| Mn (GPC) | 4900 | 5220 | 5630 | 6870 | 5150 |
| EEW, g/eq | 527 | 527 | 526 | 525 | 263 |

TABLE 3

| | Example 6L | Example 7L | Example 8L |
|---|---|---|---|
| A | 298.07 | 261.37 | 297.51 |
| B | 74.52 | 65.34 | 74.38 |
| C | 0.23 | 0.82 | 0.12 |
| GMA | 13.04 | 45.74 | 13.13 |
| BuA | 24.93 | 87.41 | 10.11 |
| BuMA | 8.59 | 30.45 | 0.12 |
| n-DDSH | | | |
| Tg (DSC), ° C. | −46 | −41 | −2 |
| Mn (GPC) | 14100 | 19570 | 11000 |
| EEW, g/eq | 510 | 510 | 254 |

TABLE 4

| | Example 6B | Example 7B | Example 8B |
|---|---|---|---|
| A | 419.4 | 490.9 | 395.4 |
| B | 93.15 | 81.68 | 92.97 |
| C | 5.89 | 5.17 | 5.88 |
| Mixture D | | | |
| GMA | 130.41 | 114.35 | 262.64 |
| Styrene | 69.86 | 61.26 | 43.25 |
| MMA | 163.01 | 142.94 | 95.30 |
| BuMA | 102.46 | 89.85 | |
| iBOA | | | 62.76 |
| n-DDSH | 15.86 | 13.89 | 41.86 |
| Tg (DSC), ° C. | 60 | 53 | 46 |
| Mn (GPC) | 4715 | 6870 | 2800 |
| EEW, g/eq | 529 | 525 | 277 |

In the tables the following abbreviations are used:

GMA=glycidylmethacrylate

BuA=n-butylacryltate

BuMA=butylamethacrylate

n-DDSH=n-dodecylmercaptan

E.E.W.=epoxy equivalent weight

MMA=methylmethacrylate

STYR=styrene

IBOA=iso-bornylacrylate

Alternatively, the high glasstransition temperature, low average molecular weight resin may be prepared in a separate synthesis and blended afterwards with the low glasstransition, high average molecular weight resins of tables 1 and 3.

The different high glasstransition temperature, low average molecular weight acrylic copolymers are prepared according the procedure as described below.

A parts of n-butylacetate are brought in a double walled flask of 5 l equipped with a stirrer, a water cooled condensor and an inlet for nitrogen and a thermoprobe attached to a thermoregulator.

The flask content is then heated and stirred continuously while nitrogen is purged through the solvent. At a temperature of 92° C. a mixture of B parts of n-butylacetate with C parts of 2,2′-azobis (2-methylbutanenitrile) are fed in the flask during 215 minutes with a peristaltic pump. 5 minutes after this start another pump is started with the feeding of mixture D (see below), during 180 minutes. The synthesis takes (start-emptying the flask) 315 minutes. The flask content is dried by means of a rotary evaporator at 160° C. (setpoint of oil bath temperature).

The acrylic copolymers thus obtained are described in table 5, in which successively the following data are given.

Table 5: high glasstransition temperature glycidyl-group containing acrylic copolymer (EX1H to EX5H) (same abbreviations are used as above)

A: parts of n-butylacetate initially brought in the flask

B: parts of n-butylacetate containing the radical initiator

C: parts of radical initiator (2,2′-azobis (2-methylbutanenitrile))

D: mixture of polymerizable monomers and transfer agent.

TABLE 5
quantities in parts pro mille

| | | EX2-4 & | | |
|---|---|---|---|---|
| | EX1H | 6-7H | EX5H | EX8H |
| A | 390.88 | 390.88 | 390.88 | 380.47 |
| B | 97.92 | 97.72 | 97.72 | 95.12 |
| C | 6.18 | 6.18 | 6.18 | 6.02 |
| Mixture D | | | | |
| GMA | 136.81 | 136.81 | 273.62 | 268.71 |
| STYR | 73.29 | 73.29 | 73.29 | 45.18 |
| MMA | 234.78 | 171.01 | 97.72 | 97.50 |
| BuMA | 43.73 | 107.49 | 43.97 | — |
| IBOA | — | — | | 64.20 |
| n-DDSH | 16.61 | 16.61 | 16.61 | 42.80 |
| Tg (DSC) (° C.) | 65.0 | 65.0 | 59 | 48.0 |
| Mn by GPC | 4700 | 4980 | 4880 | 2630 |
| E.E.W. (g/eq) | 531 | 531 | 263 | 277.4 |

### EXAMPLE 9

### Preparation of an Amorphous Polyester in a 2 Step Process

Step 1:

420.3 parts of neopentyl glycol along with 2.2 parts of n-butyltintrioctoate catalyst is placed in a conventional four-neck round bottom flask equipped with a stirrer, a distillation column connected to a water cooled condenser, an inlet for nitrogen and a thermoprobe attached to a thermoregulator.

The flask contents are heated, while stirring, under nitrogen to a temperature of circa 140° C. There upon 604.2 parts of terephthalic acid is added while stirring and the mixture is gradually heated to a temperature of 230° C. Distillation starts from about 190° C. After about 95% of the theoretical quantity of water is distilled and a transparent prepolymer is obtained, the mixture is cooled down to 200° C.

The hydroxyl functionalised prepolymer thus obtained is characterised by (AN=acid number; OHN=hydroxy number):

| | |
|---|---|
| AN = | 10 mg KOH/g |
| OHN = | 51 mg KOH/g |

Step 2:

To the first step prepolymer standing at 200° C., 117.8 parts of isophthalic acid are added. There upon, the mixture is gradually heated to 225° C. After a 2 hours period at 225° C. and when the reaction mixture is transparent, 0.9 parts of tributylphosphite are added and a vacuum of 50 mm Hg is gradually applied.

After 3 hours at 225° C. and 50 mm Hg, following characteristics are obtained:

| AN = | 37 | mg KOH/g |
|---|---|---|
| OHN = | 2 | mg KOH/g |
| ICI^{200°C.} = | 5000 | mPa · s |
| Tg (DSC)(20° C./min) = | 55° C. | |
| Mn = | 3750 | |

### EXAMPLE 10

### Preparation of an Amorphous Polyester in a Two-step Process

430.95 parts of neopentyl glycol is placed in a conventional four neck round bottom flask equipped with a stirrer, a distillation column connected to a water cooled condenser, an inlet for nitrogen and a thermometer attached to a thermoregulator.

The flask contents are heated, while stirring under nitrogen, to a temperature of circa 140° C. at which point 632.55 parts of terephthalic acid and 1.25 parts of n-butyltintrioctoate are added. The reaction is continued at 240° C. under atmospheric pressure until about 95% of the theoretical amount of water is distilled and a transparent hydroxyl functionalised prepolymer with following characteristics is obtained:

| | | |
|---|---|---|
| AN = | 11.7 | mg KOH/g |
| OHN = | 50.5 | mg KOH/g |
| ICI^{175°C.} (Cone/Plate) = | 3000 | mPa · s |

To the first step prepolymer standing at 200° C., 48.50 parts of isophthalic acid and 28.85 parts of adipic acid are added. Thereupon, the mixture is gradually heated to 230° C. After a 2 hour period at 230° C. and when the reaction mixture is transparent, 1.0 part of tributylphosphite and 1.0 part of n-butyltintrioctoate is added and a vacuum of 50 mm Hg is gradually applied. After 3 hours at 230° C. and 50 mm Hg, following characteristics are obtained:

| | | |
|---|---|---|
| AN = | 22 | mg KOH/g |
| OHN = | 2.5 | mg KOH/g |
| ICI^{200°C.} (Cone/Plate) = | 6000 | mPa · s |

The carboxyl functionalised polyester is cooled down to 180° C. and the resin is discharged.

### EXAMPLES 11-24

### Preparation of Thermosetting Powder Coating Compositions and Coatings using these Compositions

The particular glycidyl group containing acrylic copolymer blends (Ex. 1B to Ex. 5B) as illustrated above (table 2) are formulated to a white powder along with dodecanedioic acid for Ex. 1B to Ex. 4B (=formulation A) or for Ex. 5B (=formulation B).

| | |
|---|---|
| Formulation A | Formulation B |

| | | | |
|---|---|---|---|
| Ex 1B-Ex 4B | 563.9 | Ex. 5B | 478.5 |
| dodecanedioic acid | 123.8 | dodecanedioic acid | 209.2 |
| Kronos 2310 | 294.7 | Kronos 2310 | 294.7 |
| Modaflow III | 11.8 | Modaflow III | 11.8 |
| Benzoin | 5.9 | Benzoin | 5.9 |

The particlar glycidyl group containing acrylic copolymer blends (Ex. 2B and Ex 5B to Ex. 8B) as illustrated above (table 2 and 4) are formulated to a white powder along with the carboxyl functional polyester of example 9 for Ex. 6B and Ex. 2B (=formulation E) or with the carboxyl functional polyester of Example 10 for Ex. 7B (=formulation C) or with the carboxyl functional polyester of example 9 for Ex. 5B and Ex. 8B (=formulation D).

| Formulation C | | Formulation D | | Formulation E | |
|---|---|---|---|---|---|
| Ex 7B | 110.0 | Ex. 5B or | 85.2 | Ex 2B or | 156.1 |
| | | Ex 8B | | Ex 6B | |
| Ex. 10 | 577.0 | Ex. 9 | 605.5 | Ex. 9 | 531.6 |
| Kronos 2310 | 296.0 | Kronos 2310 | 296.0 | Kronos 2310 | 296.0 |
| Modaflow III | 9.9 | Modaflow III | 9.9 | Modaflow III | 9.9 |
| Benzoin | 3.5 | Benzoin | 3.5 | Benzoin | 3.5 |

The powders are prepared by dry blending and homogenisation of the different components in a PRISM 16 mm L/D 15/1 double screw at an extrusion temperature of 85° C. The homogenised mix is then cooled and ground in a REISCH ZM 100 (sieve=0.5 mm). Subsequently the powder is sieved to obtain a particle size between 10 and 100 μm.

The powder thus obtained is deposited on cold rolled steel by electrostatic deposition using the GEMA-Volstatic PCG 1 spraygun. At a film thickness between 50 and 70 μm the panels are transferred to an air-ventilated oven, where curing proceeds for 15 minutes at a temperature of 200° C. for formulation C to E and for 30 minutes at 140° C. for formulation A and B. The paint characteristics for the finished coatings are reproduced in the table 6. In the same table are given the paint characteristics of the powders based on the high glasstransition temperature, low number average molecular weight resins used as such, accordingly Formulation A for EX1H and EX2 to EX4H and EX6 to 7H and accordingly formulation B for EX 5H and EX 8H.

In this table 4:

Column 1: represents the identification of the illustrated example.

Column 2: indicates the type of formulation

Column 3: indicates the type of glycidyl-containing acrylic copolymer used in the formulation.

Column 4: indicates the sixty degree gloss, measured accordingly ASTM D 523

Column 5/6: indicates the reverse impact strength (RI) and the direct impact strength (DI) according to ASTM D 2794. The highest impact which does not crack the coating is recorded in kg.cm.

Column 7: MEK resistance. The figures indicate the number of double rubs carried out until damaging of the coating starts.

Column 8: visual evaluation:

g: smooth, glossy finish without any deficiencies like, cratering, pinholes, etc.

m: tendency towards orange peel-like appearance with gloss, at a 60° angle, below 90.

b: orange peel with gloss values at a 60° angle below 80. Appearance of deficiencies.

Column 9: storage stability

A quantity of 25 grams of powder is put in a 100 ml recipient. The recipient is placed in a waterbath in such a way that ¾ of its height is submerged. The test is started on day 1, with the temperature of the water set at 38° C.

| Set | T, (° C.) | Read test |
|---|---|---|
| day 1 | 38 | day 1 |
| day 2 | 40 | day 2 |
| day 3 | 42 | day 3 |
| day 4 | 45 | day 4 |

Every day a quotation between 5 (good) to 0 (bad) is given, according to:

| | | |
|---|---|---|
| 5: | excellent: | the powder is fluidised without problems |
| 4: | good: | the powder is fluidised with a light hand movement |
| 3: | acceptable: | the powder is fluidised with a hand movement, a few |
| | | small conglomerates are present. |
| 2: | bad: | the powder is fluidised with great problems, a lot of |
| | | agglomerates are present |
| 0: | very bad: | the powder can not be fluidised |

On the last day of the test period quotation is given on the co-agglomeration of the powder:

| | |
|---|---|
| ++: | no agglomerates are present |
| +: | a few small agglomerates are present, which can be powdered |
| | using small pressure |
| +−: | greater agglomerates are present, which can be powdered |
| | using small pressure |
| −: | rather hard agglomerates |
| −−: | hard agglomerates |
| −−−: | one block has been formed |

TABLE 6

| | | acrylic | gloss | RI | DI | MEK | Visual | |
|---|---|---|---|---|---|---|---|---|
| Powder | Formulation | copolymer | 60° | (kg.cm) | (kg.cm) | Rubs | evaluatio | Storage |
| Ex. 11 | A | Ex. 1B | 89 | 20 | 40 | 80 | g | 5, 4, 4, 4+ |
| Ex. 12 | A | Ex. 2B | 90 | 40 | 40 | 100 | g | 5, 4, 4, 4+ |
| Ex. 13 | A | Ex. 3B | 92 | 40 | 60 | 100 | g | 5, 4, 4, 3+ |
| Ex. 14 | A | Ex. 4B | 95 | 60 | 60 | 100 | g | 5, 4, 4, 3+ |
| Ex. 15 | B | Ex. 5B | 90 | 40 | 40 | 120 | g | 5, 4, 4, 3+ |
| Ex. 16 | E | Ex. 6B | 96 | 60 | 80 | 100 | g | 5, 4, 4, 4+ |
| Ex. 17 | E | Ex. 2B | 95 | 80 | 100 | 80 | g | 5, 4, 4, 3+ |
| Ex. 18 | C | Ex. 7B | 89 | 80 | 80 | 80 | g | 5, 4, 4, 3+ |
| Ex. 19 | D | Ex. 5B | 90 | 100 | 120 | 100 | g | 5, 4, 4, 3+ |
| Ex. 20 | D | Ex. 8B | 89 | 120 | 140 | 50 | g | 5, 4, 4, 4++ |
| Ex. 21 | A | Ex. 1H | 86 | <20 | <20 | 90 | m | 5, 5, 5, 4+ |
| Ex. 22 | A | Ex. 2-4/ | 89 | <20 | <20 | 90 | m | 5, 4, 4, 4+ |
| | | 6-7H | | | | | | |
| Ex. 23 | B | Ex. 5H | 85 | <20 | <20 | 100 | b | 5, 4, 4, 4+ |
| Ex. 24 | B | Ex. 8H | 81 | <20 | <20 | 120 | m | 5, 4, 3, 2+ |

As clearly appears from a comparison between EX 11 to EX 20 on the one hand and of EX 21 to EX 24 (being comparative examples) on the other hand, a clear improvement in film flexibility (reverse and direct impact) as well as an improved aspect of the cured paint is observed when using a blend of a low glasstransition temperature, high average molecular weight and a high glasstransition temperature, low average molecular weight resin. When not using the particular blend of this invention but only the high glasstransition temperature, low average molecular weight resin as such, a paint proving a marked orange peel is observed. Moreover, low mechanical properties are obtained (less than 20 kg.cm for reverse and direct impact).

### COMPARATIVE EXAMPLES

The improvement in aspect as well as flexibility of the coated film, obtained after curing a powder based on the particular blend of this invention is still more expressed when using an acrylic copolymer blend not answering the criteria as claimed in this invention. Thus, a powder coating, derived from a blend of two glycidyl-group containing acrylic copolymers but based on a mixture of a high glasstransition temperature, high number average molecular weight acrylic copolymer and a low glasstransition temperature, low number average molecular weight acrylic copolymer, such as for example claimed in EP-A-0 544 206 (Mitsui Toatsu Chem. Inc.), on application, proves a paint film with reduced appearance and flexibility. By way of comparative examples, two high glasstransition temperature, high average molecular weight acrylic copolymers (comparative examples 1 and 2) as well as one low glasstransition temperature, low average molecular weight acrylic copolymer (comparative ex. 3) were prepared accordingly the procedure as described below.

X parts of xylene were fed into a four-necked flask equipped with a stirrer, a thermometer, a reflux condensor and a nitrogen inlet tube. The flask contents were heated to its reflux temperature. Thereto were dropwise added in 5 hours the monomers and N,N′-azobisisobutyronitrile (initiator) in amounts as shown in table 7. The resulting mixture was kept at 100° C. for 5 hours. Then, the solvent was removed from the reaction mixture.

TABLE 7
quantities are in parts pro mille

| | Comp. ex. 1 | Comp. ex. 2 | Com. ex. 3 |
|---|---|---|---|
| X: Xylene (base of solvent) | 397.73 | 399.19 | 391.23 |
| Mixture of monomers | | | |
| Glycidyllmethacrylate | 178.89 | 149.60 | 322.56 |
| Styrene | 89.44 | 59.84 | — |
| Isobornylmethacrylate | 226.59 | 388.96 | — |
| methyl methacrylate | 101.37 | — | — |
| butyl acrylate | — | — | 117.29 |
| 2-ethylhexyl acrylate | — | — | 146.62 |
| n-dodecylmercaptan | — | — | — |
| N,N′-azobisisobutyronitrile | 5.96 | 2.39 | 22.29 |
| Total of parts | 1000 | 1000 | 1000 |
| Mn by GPC | 6415 | 11315 | 1295 |
| Tg (DSC) (° C.) | 60 | 45 | −0.5 |
| E.E.W. (g/eq) | 473 | 568 | 258 |

The acrylic copolymers of comparative examples 1, 2 and 3 then were formulated into a white powder along with 1,12-dodecanedioic acid according the formulations as illustrated in comparative examples 4 and 5.

| Constituent | Comp. ex. 4 | Comp. ex. 5 |
|---|---|---|
| Comp. ex. 1 | 499.7 | — |
| Comp. ex. 2 | — | 468.9 |
| Comp. ex. 3 | 88.4 | 156.3 |
| 1,12-dodecanedioic acid | 201.3 | 164.2 |
| Kronos 2310 | 197.3 | 197.3 |
| Resflow PV 5 | 9.8 | 9.8 |
| Benzoin | 3.5 | 3.5 |

The powders then are prepared and applicated in the same way as for EX1B to EX8B. For comparative example 5, no application was possible due to coagulation of the premix leading to huge processability problems (extrusion). The powder of comparative example 4 after curing at 140° C. for 30 minutes was evaluated as for table 6. The results of this evaluation being shown in table 8.

TABLE 8

| | Comparative |
|---|---|
| | example 4 |
| Gloss at 60° | 86 |
| Reverse impact (kg.cm) | <20 |
| Direct Impact (kg.cm) | <20 |
| MEK rubs | 90 |
| Visual evaluation | m |
| Storage stability | 2, 2, 0, 0−− |

As can be seen from a comparison between table 6 and 8, the use of a blend of a low glasstransition temperature, high average molecular weight and a high glasstransition temperature, low average molecular weight resin has a significant effect on overall appearance (gloss, visual evaluation) as well as on flexibility of the cured paint.

Besides, from the same comparison, it gets obvious that all those properties only are obtained when using the particular blend of this invention. Not using the criteria as claimed in this invention, but using for example a blend of a low glasstransition temperature, low average molecular weight and a high glasstransition temperature, high average molecular weight acrylic copolymer, or a high glasstransition temperature, low average molecular weight acrylic copolymer as such not only deteriorates the appearance of the paint but also reduces its flexibility. Moreover a negative effect on processability, or, for some cases on storage stability, is obtained.

1. Composition for thermosetting powder coating comprising a co-reactable blend of two glycidyl group containing acrylic copolymers and a carboxylic group containing compound, wherein:
(a) a first glycidyl group containing acrylic copolymer (a) has a high glass transition temperature in the range of from +45 to +100° C. and a number average molecular weight in the range of from 2500 to 5000
(b) a second glycidyl group containing acrylic copolymer (b) has a low glass transition temperature in the range of from −50 to +30° C. and a number average molecular weight in the range of from 5000 to 20000,
(c) the carboxylic group containing compound is selected from the group comprising:
1) a carboxylic group containing polyester, the acrylic copolymer (a) being present in 60-95 parts by weight and the acrylic copolymer (b) being present in 5-40 parts by weight, calculated on the total weight of (a) and (b);
2) a polycarboxylic acid, the acrylic copolymer (a) being present in 60-80 parts by weight and the the acrylic copolymer (b) being present in 20-40 parts by weight, calculated on the total weight of (a) and (b);

2. Composition according to claim 1, wherein the glycidyl group containing acrylic copolymer (a) has an epoxy equivalent in the range of from 200 to 800 g/eq and the glycidyl group containing acrylic copolymer (b) has an epoxy equivalent in the range of from 200 to 1000 g/eq.

3. Composition according to any of claims 1 or 2, wherein the equivalent ratio of the total epoxy groups of the acrylic copolymer (a) and the acrylic copolymer (b) to the acid groups of the carboxylic group containing compound is 0.5 to 2 and preferably 0.8 to 1.2.

4. Composition according to any of the proceeding claims, wherein the acrylic copolymers (a) and (b) comprise
1-95 mole percent of one or more monomers selected from methyl(meth)acrylate, ethyl(meth)acrylate, propyl(meth)acrylate, n-butyl(meth)acrylate, isobutyl(meth)acrylate, tert.butyl(meth)acrylate, 2-ethylhexyl(meth)acrylate, stearyl(meth)acrylate, tridecyl(meth)acrylate, cyclohexyl(meth)acrylate, n-hexyl(meth)acrylate, benzyl(meth)acrylate, phenyl(meth)acrylate, isobornyl(meth)acrylate, nonyl(meth)acrylate, hydroxyethyl(meth)acrylate, hydroxypropyl(meth)acrylate, hydroxybutyl(meth)acrylate, 1,4-butandiol mono(meth)acrylate, the esters of methacrylic acid, maleic acid, maleic anhydride, itaconic acid, dimethylaminoethyl(meth)acrylate, diethylaminoethyl(meth)acrylate, styrene, α-methylstyrene, vinyltoluene, (meth)acrylonitrile, vinylacetate, vinylpropionate, acrylamide, methacrylamide, methylol(meth)acrylamide, vinylchloride, ethylene, propylene, C4-20 olefins and α-oleflns and 5-99 mole percent of one or glycidyl group containing monomers selected from glycidylacrylate, glycidylmethacrylate, methylglycidylmethacrylate, methylglycidylacrylate, 3,4-epoxycyclohexylmethyl(meth)acrylate, 1,2-ethyleneglycol glycidylether(meth)acrylate, 1,3-propyleneglycolglycidylether(meth)acrylate, 1,4-butyleneglycolglycidylether(meth)acrylate. 1,6-hexanediolglycidylether(meth)acrylate, 1,3-(2-ethyl-2-butyl)-propanediolglycidylether(meth)acrylate and acrylic glycidylethers.

5. Composition according to any of the preceding claims, wherein the polycarboxylic acid constituent is selected from
an aliphatic polycarboxylic acid such as adipic acid, pimelic acid, suberic acid, azelaic acid, sebacic acid, undecanedioic acid, tridecanedioic acid, tetradecanedioic acid, pentadecanedioic acid, hexadecanedioic acid, octadecancedioic acid, eicosanedioic acid, 1,10-dodecanedioic acid, docosanedioic acid or tetracosanedioic acid,
a cycloaliphatic polycarboxylic acid such as hexahydrophthalic acid, tetrahydrophthalic acid, 1,2-cyclohexanedicarboxylic acid, 1,3-cyclohexanedicarboxylic acid or 1,4-cyclohexanedicarboxylic acid, or
an aromatic polycarboxylic acid such as isophthalic acid, phthalic acid or trimellitic acid.

6. Composition according to any of claims 1-4, wherein the carboxyl group containing polyester is preferably prepared from an acid constituent selected from terephthalic acid, fumaric acid, maleic acid, isophthalic acid, phthalic acid, 1,4-cyclohexanedicarboxylic acid, 1,3-cyclohexanedicarboxylic acid, 1,2-cyclohexanedicarboxylic acid, 1,10-dodecanedioic acid, succinic acid, glutaric acid, adipic acid, pimelic acid, suberic acid, azelaic acid, sebacic acid, and the corresponding anhydrides or esters and an alcohol constituent selected from neopentyl glycol, ethylene glycol, diethylene glycol, 1,4-butanediol, 1,6-hexanediol, propylene glycol, 1,4-cyclohexanedimethanol, 1,4-cyclohexanediol, hydrogenated Bisphenol A, 2-ethyl-2-butyl- 1,3-propanediol, 2-methyl- 1,3-propanediol, hydroxypivalate of neopentyl glycol and 2,2-bis(4-hydroxycyclohexyl)propane.

7. Composition according to claim 6, wherein the carboxyl group containing polyester is branched by incorporation of polyols, polyacids or the corresponding anhydrides, preferably selected from trimethylolpropane, di-trimethylolpropane, pentaerythritol, trimellitic anhydride and pyromellitic anhydride.

8. Composition according to any of claims 6-7, wherein the carboxyl group containing polyester has an acid number of 20-150 mg KOH/g, a hydroxyl number of not more than 15 mg KOH/g, a glasstransition temperature of at least −20° C. (DSC 20°/min) and a number average molecular weight in the range of from 750 to 8000 (GPC homodisperse polystyrene standards).

9. Method of preparing a composition for thermosetting powder coating as claimed in any of claims 1-8 comprising the step of mixing a blend of a glycidyl group containing acrylic copolymer (a) having a glass transition temperature in the range of +45 to +100° C. and a number average molecular weight in the range of from 2500 to 5000 and a glycidyl group containing acrylic copolymer (b) having a glass transition temperature in the range of from −50 to +30° C. and a number average molecular weight in the range of from 5000 to 20000 with a carboxylic group containing compound.

10. Method according to claim 9, wherein the blend of the glycidyl group containing acrylic copolymers (a) and (b) is prepared by first preparing the glycidyl group containing acrylic copolymer (b) and then using this copolymer in a further stage as a polymeric diluent for the synthesis of the glycidyl group containing acrylic copolymer (a).

11. Method of preparing a coating on a metallic or non-metallic surface of a substrate comprising the steps of partially or entirely coating the surface of the substrate with a composition of any of claims 1-8 and heating the coated substrate to obtain a thermoset coating.

12. Coating, preparable by the method of claim 11.

13. Substrate, entirely or partially coated with the coating of claim 12.
